(19) United States
(12) Patent Application Publication
(10) Pub. No.: US 2010/0215494 A1
(43) Pub. Date: Aug. 26, 2010

(54) Wind Turbine Rotor Blade

(75) Inventors: Anton Bech, Ringkobing (DK); Dongke Sun, Isle of Wight (GB)

Correspondence Address: COHEN, PONTANI, LIEBERMAN & PAVANE LLP, 551 FIFTH AVENUE, SUITE 1210, NEW YORK, NY, 10176, US

(73) Assignee: Vestas Wind Systems A/S, Randers (DK)

(21) Appl. No.: 12/415,149

(22) Filed: Mar. 31, 2009

(30) Foreign Application Priority Data
Feb. 25, 2009 (GB) 0903109.7

(51) Int. Cl. F03D 7/00

(52) U.S. Cl. 416/31

(57) ABSTRACT

A wind turbine rotor blade is provided comprising a main body portion and a movable auxiliary component. The auxiliary component is mounted about a leading edge of the main body portion. The auxiliary component comprises first and second longitudinally extending edges together with an arcuate surface extending therebetween. The first edge is connected to a pressure surface of the main body portion to form a substantially continuous surface therewith.

The auxiliary component is configured to be moved from a first, deployed position to a second, retracted position dependent on the incident wind speed.

The present invention relates to wind turbine rotor blades and, in particular, to a device for temporarily increasing the chord length of a root portion of a rotor blade at low wind speeds.

At low wind speeds, conventional wind turbine rotors struggle to generate power, this is primarily due to the bulk, and therefore inertia associated with the rotor blades. Wind turbine rotor blades are typically in excess of 40 metres long. Consequently, the structure of each rotor blade is significant and the aerodynamic forces associated with low wind speeds are insufficient to rotate the rotor blade such that a reasonable amount of power can be generated thereby. A lack of lift is most noticeable in respect of a root portion of the rotor blade.

Conventionally, the rotor blade is twisted from tip to root to present a root portion having a greater pitch angle than the remainder of the blade. Such twisting of the blade represents complex geometrical constraints that exhibit correspondingly complex structural behaviour. Furthermore, the dimension of a chord of the rotor blade is increased towards the root portion of the rotor blade in order to further enhance the lift characteristics in this region, especially at lower wind speeds. However, any increase in these dimensions dominates the overall envelope of the rotor blade and, therefore, leads to increases in manufacturing costs, transportation costs and material costs.

Rotor blades experience significant structural loading in operation, not only due to the aerodynamic loads exerted thereon but also due to the magnitude and weight of the structure of the rotor blade itself. These loads are primarily transmitted to a spar member and from there to a hub of the wind turbine.

In operation, the rotor blades of a wind turbine rotate through a substantially vertically orientated plane. Consequently, significant cyclic loading is experienced by each blade. In particular, fluctuating tensile and compressive loads are experienced along a foremost of “leading” edge of the blade and along a rearmost or “trailing” edge of the blade. Hereinafter, these particular loads are referred to as “edge-wise loads”. The edge-wise loads are most significant in a root region of the rotor blade, for example for the 30% of the blade nearest to the hub of the wind turbine (once installed).

Whilst the edge-wise loads are experienced by both the leading edge and the trailing edge, the trailing edge is located further from the neutral axis of the rotor blade and therefore higher strains are experienced along the trailing edge.

In some rotor blades the cross section varies from representing an aerofoil at a region of maximum chord dimension to becoming circular in cross section at a root of the rotor blade. Such a complex variation in geometry means that the curvature described by the trailing edge (when viewed in plan form) is extreme. As the curvature is more extreme, the fluctuating strains experienced by the material bounded by the trailing edge are correspondingly increased.

It follows that, if the local chord length is permanently increased, then as the wind speed increases in normal operating conditions, significant loading will be experienced by the rotor blade, particularly in the root region, and by the hub supporting the rotor blade. In extreme wind conditions (e.g. gusting winds), such increased loading could lead to damage to the wind turbine installation.

It is, therefore, desirable to enhance the lift characteristics of the rotor blade in light wind conditions without substantially increasing the weight of the rotor blade or the overall dimensions of the rotor blade.

According to a first aspect, the present invention provides a wind turbine rotor blade comprising:
a main body portion; and
a movable auxiliary component, mounted about a leading edge of the main body portion, the auxiliary component comprising first and second longitudinally extending edges and an arcuate surface extending therebetween, the first edge being connected to a pressure surface of the main body portion to form a substantially continuous surface therewith, the auxiliary component being configured to be moved from a first, deployed position to a second, retracted position dependent on the incident wind speed.

By providing a rotor blade with a moveable auxiliary component, an increase in chord length and camber of a cross-section of the rotor blade in a root portion thereof, is achieved as required. A corresponding increase in lift is generated by the root portion of the rotor blade, especially at low wind speeds. By increasing the distance from a leading edge of the rotor blade to a neutral axis, the distance from the neutral axis to a trailing edge of the rotor blade can be reduced. Clearances between the rotor blade and a wind turbine tower to which the rotor blade is connected in use are, therefore, increased.

Furthermore, the complexity of the geometry of the trailing edge is reduced when compared to a trailing edge of a conventional rotor blade (i.e. the trailing edge is straighter with less twisting). Edge-wise loads along the trailing edge of the rotor are transmitted more directly and, therefore, more robustly.

The auxiliary component may extend longitudinally along the rotor blade from a root of the rotor blade to a position approximately 50% of the distance to a tip of the rotor blade or preferably to a position approximately 20-30% of the distance to a tip of the rotor blade.

Vortex generators may be mounted on the auxiliary component in the vicinity of the second longitudinally extending edge, to disguise a discontinuity in geometry of a suction surface of the rotor blade brought about by the presence of the second longitudinally extending edge. Biasing means may be located between the auxiliary component and the main body portion, the biasing means being configured to inhibit separation of the second longitudinally extending edge and a suction surface of the main body portion. Thus the discontinuity in geometry of the suction surface of the rotor blade is minimised.

The rotor blade may comprise deployment means for moving the auxiliary component from the first position to the second position. The deployment means may comprise an actuator, for example a hydraulic piston or an electric motor with a spindle, the actuator extending between the auxiliary component and the main body portion. The deployment means may be configured to receive instructing signals from a central controller associated with a wind turbine installation to which the rotor blade is connected, in use.

The deployment means may be configured to move the auxiliary component between the first and second portions dependent on an orientation of the rotor blade relative to a hub of a wind turbine installation to which the rotor blade is connected, in use.

The deployment means may comprise a push-rod connected to the auxiliary component, the push-rod being configured to engage with a receiving means, the receiving means being fixedly connected to a hub of a wind turbine installation to which the rotor blade is connected, in use. In this way, the deployment means takes advantage of an established control mechanism used to rotate the rotor blade. The deployment means may comprise biasing means associated with the push-rod, configured to assist retraction of the auxiliary component.

According to a second aspect, the present invention provides a wind turbine installation comprising:
a tower;
a hub, mounted atop the tower; and
a wind turbine rotor blade, of the aforementioned type, connected to the hub.

By “substantially continuous surface” we mean that the surface presented to the incident airstream is without significant disruptive features such as protrusions or gaps in the surface. Furthermore, tangential variation in the surface is preferably smooth such that discontinuous changes in curvature are avoided.

The present invention will now be described in more detail, by way of example only, in reference to the following figures in which:

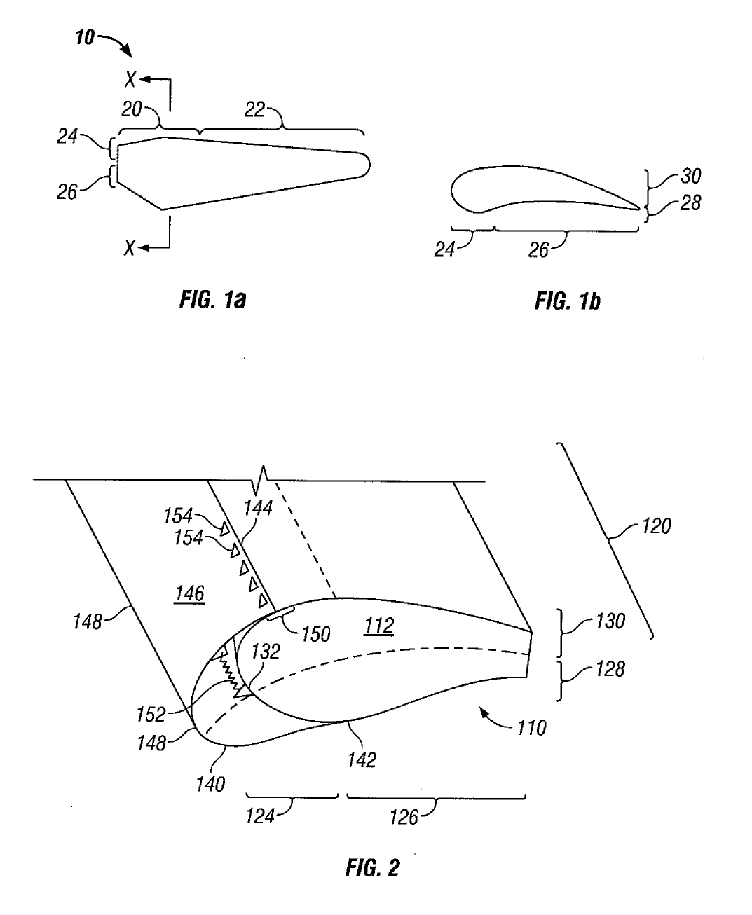

FIG. 1 represents a conventional wind turbine rotor blade in a) plan form and b) cross-section (at X-X of FIG. 1a);

FIG. 2 represents a wind turbine rotor blade with a modified leading edge in a low wind speed condition;

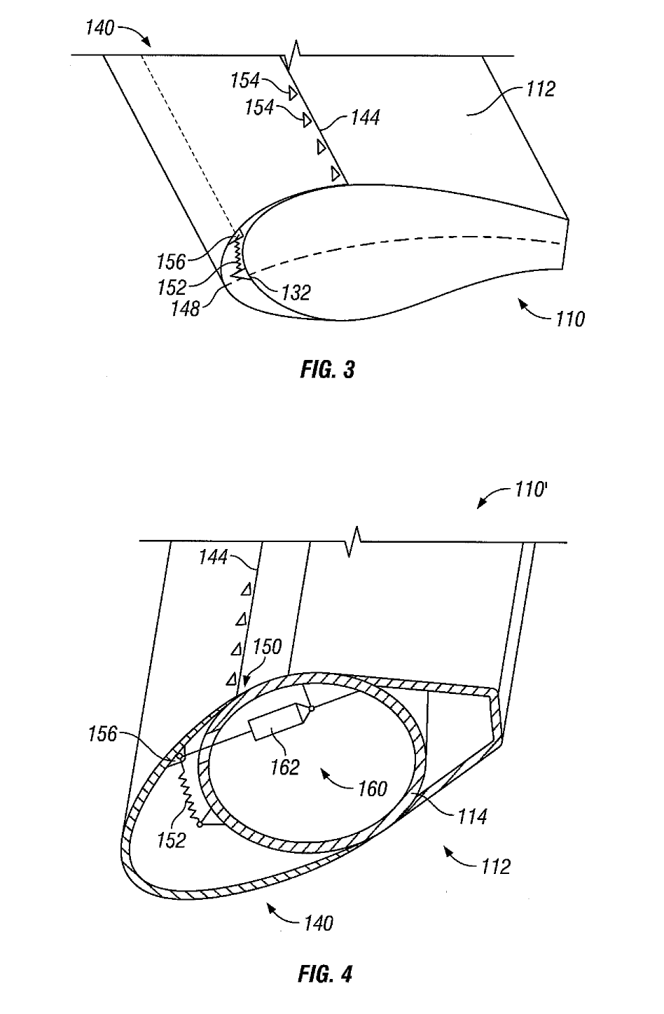

FIG. 3 represents the rotor blade of FIG. 2 in a high wind speed condition;

FIG. 4 represents a first actuation mechanism;

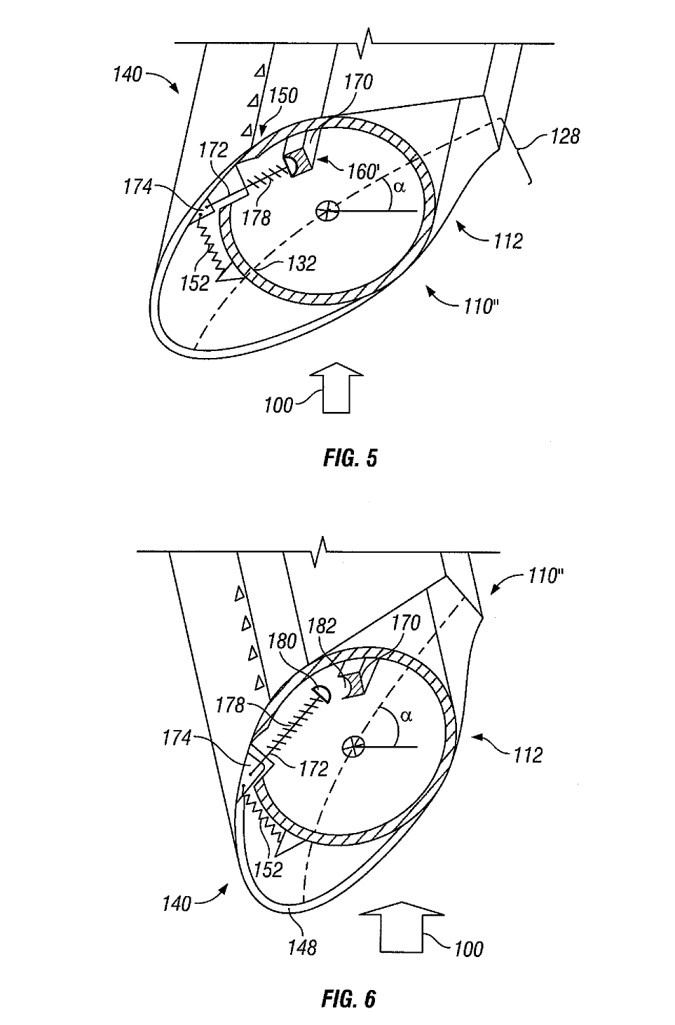

FIG. 5 represents a second actuation mechanism in low wind conditions; and

FIG. 6 represents the actuation mechanism of FIG. 5 in high wind conditions.

FIG. 1a illustrates a conventional rotor blade 10 in plan form. The rotor blade 10 comprises a root portion 20 and a tip portion 22. The root portion is arranged to be connectable to a hub of a wind turbine tower (not shown) and forms the proximal portion of the rotor blade 10. The tip portion 22 extends from the root portion 20 and represents the distal portion of the rotor blade 10.

When installed in a wind turbine tower the, or each, rotor blade 10 rotates about a central axis of the hub. In so doing, one portion of the rotor blade 10, a leading portion 24 encounters the incident airflow and a second region of the rotor blade 10, the trailing portion 26, follows. FIG. 1b illustrates a cross-section of the rotor blade 10 taken on X-X illustrated in FIG. 1a. In operation, the rotor blade 10 experiences a pressure difference across the thickness of the cross-section of the blade. The higher pressure side (depicted in a lower part of FIG. 1b) will hereinafter be referred to as the “pressure” surface 28 and the lower pressure side (depicted in an upper part of FIG. 1b) will hereinafter be referred to as the “suction” surface 30.

By virtue of the rotation of the rotor blade 10 about the hub, the tip portion 22 travels faster than the root portion 20 and, consequently, encounters higher wind speeds. The lift generated by the tip portion 22 is, therefore, greater than that generated by the root portion 20. This variation in lift governs the design of the overall shape of the rotor blade 10. Namely, the root portion 20 is broader, having a larger chord length, and the tip portion 22 is more slender having a smaller chord length.

Additionally, twist is introduced into the rotor blade and increases progressively from the tip portion 22 to the root portion 20. In other words, the angle of attack of a cross-section profile of the rotor blade 10 at the tip 22 is less than a corresponding section taken adjacent to the root portion 20.

In light wind conditions, when wind speeds are particularly low, the performance of conventional wind turbine rotors is notably reduced.

FIG. 2 represents a modified rotor blade 110 which endeavours to capture a greater level of power at low wind speeds. Similar components to those described in relation to FIG. 1 are numbered similarly. The rotor blade 110 comprises a blade body 112 and an auxiliary component 140. The blade body 112 may comprise an integral structure as illustrated in FIG. 2 or it may comprise a separate load bearing spar member 114 (of the type illustrated in FIG. 4).

The auxiliary component 140 is connected to a leading portion 124 of the rotor blade body 112 at a root portion 120 such that an extreme front region or integral leading edge 132 of the leading portion 124 is covered by the auxiliary component 140. The auxiliary component 140 comprises a concave, substantially two-dimensional surface, and is shaped so as to mimic the shape of the leading portion 124 of the rotor blade body 112 in the root portion 120. The auxiliary component 140 comprises first and second longitudinal edges 142, 144 and an arcuate surface 146 located therebetween.

The first longitudinal edge 142 of the auxiliary component 140 is connected to a pressure surface 128 of the rotor blade body 112. The first edge 142 is preferably bonded or riveted to the pressure surface 128 of the rotor blade body 112 to prevent, or at least inhibit, ingress of air through an interface between the auxiliary component 140 and the rotor blade body 112. The second longitudinal edge 144 of the auxiliary component 140 is located adjacent to a suction surface 30 of the rotor blade body 112.

The auxiliary component 140 is connected to the leading portion 124 in such a way that a foremost section or aerodynamic leading edge 148 of the arcuate surface 146 is spaced from the integral or structural leading edge 132 of the rotor blade body 112 at low wind speeds, say below 12 ms⁻¹. The auxiliary component 140 is made from a resilient, pliable material, such as a fibre reinforced composite material. The auxiliary component 140 is configured such that, at particular elevated wind speeds, say 12 ms⁻¹ and above, the auxiliary component 140 is deflected towards the rotor blade body 112 (as illustrated in FIG. 3). Thus, the arcuate surface 146 of the auxiliary component 140 substantially conforms to the surface of the leading portion 124 of the rotor blade body 112.

By deploying the auxiliary component 140 (as illustrated in FIG. 2) the chord length of the rotor blade 110 may be extended by up to 20% of the original chord length. Preferably, the extent of the increase in chord length is in the range of 10-15% of the original chord length.

In addition to providing an increased chord length, the camber of the aerofoil section is also increased when the auxiliary component 140 is deployed. This increased camber further enhances the lift generated by the rotor blade 110 in the region in which the auxiliary component is installed.

The auxiliary component 140 is made from light weight materials such that the overall weight of the rotor blade 110 is not particularly increased and nor, therefore, are the loads experienced by the rotor and the hub. Thus, it is not necessary to extensively reinforce the wind turbine tower.

In the deployed position shown in FIG. 2, a discontinuity 150 in the suction surface 130 may be apparent between the auxiliary component 140 and the rotor blade body 112. It is preferable to minimise such a discontinuity 150, and so a biasing means, here provided by spring 152, is introduced. Spring 152 is connected between the structural leading edge 132 of the rotor blade body 112 and the auxiliary component 140. The spring 152 is preferably connected to the auxiliary component 140 at an attachment point 156 located in the vicinity of the second longitudinal edge 144 as shown. The spring 152 serves to urge the second longitudinal edge 144 against the suction surface 130 of the rotor blade body 112 and thus minimise any geometrical discontinuity 150 in the suction surface 130.

The discontinuity 150 can disrupt the air flow over the rotor blade 110 leading to separation of the flow (especially if the flow is laminar) and, therefore, to an undesirable increase in drag over the rotor blade 110. Vortex generators 154 may be appended to the auxiliary component 140 along the second longitudinal edge 144, as shown in FIG. 2, to encourage turbulence in the flow and thereby initiate transition. Furthermore, the vortex generators 154 cause circulation in the air flow about an axis extending in a chord-wise sense This circulation encourages highly energised fluid to be drawn into a boundary layer formed on the suction surface 130. This behaviour further delays stall from occurring. Stall is delayed from occurring when the rotor blade is at an angle of approximately 10° to the incident flow stream, to occurring when the rotor blade is at an angle of approximately 15-16° to the incident flow stream. The vortex generators 154 effectively hide the geometric discontinuity 150 between the auxiliary component 140 and the suction surface 130, hence an improved lift characteristic is generated.

The auxiliary component 140 is configured to be actively actuable relative to the rotor blade 110. The following two embodiments exemplify how such actuation can be achieved.

In one embodiment, as illustrated in FIG. 4, a rotor blade 110′ comprises actuator means 160, here a hydraulic piston 162, connected between a rotor blade body 112 and an auxiliary component 140. At the rotor blade body 112, the hydraulic piston 162 is connected to a spar portion 114 of the rotor blade body 112. At the auxiliary component 140, the hydraulic piston 162 is connected to an attachment point 156 located in the vicinity of the second longitudinal edge 144. The attachment point 156 may be the same as, or coincident with, that used to anchor/secure the spring 152 to the auxiliary component 140. The spring 152 not only serves to urge the second longitudinal edge 144 into the suction surface 130 but also enhances the stability of the actuator means 160.

The actuator means 160 is configured to receive control signals from a central controller (not shown) of the turbine installation. One of the inputs to the central controller is local wind speed and direction as experienced by the turbine installation. The auxiliary component 140 can, therefore, be deployed in light wind conditions to increase the chord length and camber locally by spacing the aerodynamic leading edge 148 of the auxiliary component 140 from the structural leading edge 132 of the rotor blade body 112 and thereby enhance the lift generated by the rotor blade 110′. As the wind conditions become heavier, the auxiliary component 140 can be retracted to reduce both the chord length and the camber of the rotor blade 110′, thus protecting the rotor blade 110′ from inadvertent damage due to sudden gusting winds. Alternatively, actuator means 160 may be provided by an electric motor in combination with a spindle (not shown).

Another embodiment, comprising an alternative rotor blade 110″, is illustrated in FIGS. 5 and 6. In this embodiment, actuation of an auxiliary component 140 is effected by rotation of the rotor blade 110″ about an axis of the hub. As wind conditions change the, or each, rotor blade is conventionally rotated about a common longitudinal axis through the blade and the hub to optimise the aerodynamic loading on the rotor blade. At low wind speeds (in the range from approximately 4 ms⁻¹ to 12 ms⁻¹) the rotor blades are orientated such that the pressure side 128 of the aerofoil is presented directly to the predominant wind direction 100 for a bulk portion of the rotor blade 110″. Hereafter, this orientation of rotor blade is referred to as representing a pitch angle of approximately 0°. As the wind speed increases, in excess of 12 ms⁻¹, each rotor blade rotates about the respective longitudinal axis away from the wind, increasing the pitch angle so that the incident wind direction becomes more chord-wise. This increase in pitch angle effectively depowers the rotor blade, thus maintaining a relatively constant level of power generation over the operational envelope and preventing the turbine from generating more energy than its components are able to accommodate without experiencing damage. In FIGS. 5 and 6 a root portion 120 of the rotor blade 110″ is depicted. The root portion 120 is twisted relative to the bulk portion of the rotor blade 110″ and so the angle α represents the combined pitch and twist angles experienced by this portion 120 of the rotor blade 110″.

Alternative actuator means 160′, implemented in the latter embodiment, makes use of the relative motion between the blade and the rotor hub to optimally position the auxiliary component 140 with respect to the rotor blade body 112.

Actuator means 160′ comprises a cantilever beam 170, rigidly connected to an interior of the hub. The beam 170, consequently, remains static when the rotor blade body 112 is rotated relative to the hub during normal operation of the wind turbine installation as described above. Actuator means 160′ comprises a push-rod 172, about which is positioned a spring 178. One end of the push-rod 172 is connected to attachment point 174 on the auxiliary component 140, attachment point 174 may be the same as, or coincident with, attachment point 156 used to secure spring 152. The other end of the push-rod 172, provided with an abutment 180, is configured to be received by a recess 182 formed in the cantilever beam 170.

In FIG. 5, the incident wind 100 is received by the rotor blade 110″ on the pressure side 128 of the aerofoil section. The pitch angle α is small (say in the range −2° to 2°) to ensure maximum harnessing of the wind energy by the rotor blade 110″. Under these conditions, the abutment 180 of the push-rod 172 engages with the recess 182 of the cantilever beam 170 so that the spring 178 is compressed. The auxiliary component 140 is, thus, deployed such that the aerodynamic leading edge 148 is spaced from the structural leading edge 132 of the rotor blade body 112. The chord length of the root portion of the rotor blade 110″ is, therefore, increased together with the camber, such that the aerodynamic lift generated by the rotor blade in this region is enhanced.

Moving to FIG. 6, the incident wind 100 has increased in speed (say exceeding 12 ms⁻¹) and the rotor blade 110″ is reorientated by a central controller so that the leading edge of the rotor blade 110″ is turned into the wind 100 (i.e. pitch α is increased as shown). The rotor blade 110″ is, therefore, more closely aligned with the wind and the pitch angle α is consequently increased. The abutment 180 of the push-rod 172 disengages from the recess 182 in the cantilever beam 170 and the spring 178 aids retraction of the auxiliary component 140 so that the aerodynamic leading edge 148 returns towards the structural leading edge 132 of the rotor blade body 112. Meanwhile, spring 152 continues to urge the second longitudinal edge 144 of the auxiliary component 140 towards the suction surface 130 of the rotor blade 110″ thus minimising any gap at discontinuity 150. The chord length and the camber of rotor blade 110″ are reduced, leading to a corresponding reduction in aerodynamic lift generated locally by the root region of the rotor blade 110″.

By using the orientation of the rotor blade 110″ as governed by the central controller of the wind turbine installation, the level of complexity introduced is limited as no additional electronics are involved. Rather, only mechanical mechanisms using established technology are exploited.

In either embodiment, the auxiliary component 140 extends along the leading edge of the rotor blade 110′, 110″ from root portion for up to 50% of the length of the rotor blade, preferably approximately 20 to 30% of the length of the rotor blade.

A rotor blade implementing the present invention exhibits a shorter chord length especially in the root region of the rotor blade. A compact rotor blade of this type not only uses less material leading to cost savings but is also able to take advantage of narrower moulds in the manufacturing process and narrower transportation vessels/vehicles leading to additional cost benefits.

Twisting of the rotor blade is not eliminated, rather, the fluctuation in geometry is provided for at the leading edge of the rotor blade via the auxiliary component concept, thus providing an adaptive leading edge. Consequently, the trailing edge of the rotor blade becomes straighter and simpler and thus improves the overall structural integrity of the rotor blade. Local buckling and debonding associated with the complex geometries of conventional blades can, therefore, be minimised if not avoided completely.

By providing an adaptive leading edge in this way, a rotor blade having a dynamically changing profile in response to changes in wind conditions is effectively provided. Such a rotor blade is able to maximise the output of energy production for a wind turbine installation.

The invention has been described with reference to specific examples and embodiments. However, it should be understood that the invention is not limited to the particular example disclosed herein but may be designed and altered with the scope of the invention in accordance with the claims.

1. A wind turbine rotor blade comprising:
a main body portion; and
a movable auxiliary component, mounted about a leading edge of the main body portion, the auxiliary component comprising first and second longitudinally extending edges and an arcuate surface extending therebetween, the first edge being connected to a pressure surface of the main body portion to form a substantially continuous surface therewith, the auxiliary component being configured to be moved from a first, deployed position to a second, retracted position dependent on the incident wind speed.

2. A rotor blade according to claim 1, wherein the auxiliary component extends longitudinally along the rotor blade from a root of the rotor blade to a position approximately 50% of the distance to a tip of the rotor blade.

3. A rotor blade according to claim 2, wherein the auxiliary component extends longitudinally along the rotor blade from a root of the rotor blade to a position approximately 20-30% of the distance to a tip of the rotor blade.

4. A rotor blade according to claim 1, wherein vortex generators are mounted on the auxiliary component in the vicinity of the second longitudinally extending edge.

5. A rotor blade according to claim 1, comprising biasing means located between the auxiliary component and the main body portion configured to inhibit separation of the second longitudinally extending edge and a suction surface of the main body portion.

6. A rotor blade according to claim 1, wherein the rotor blade comprises deployment means for moving the auxiliary component from the first position to the second position.

7. A rotor blade according to claim 6, wherein the deployment means comprises an actuator extending between the auxiliary component and the main body portion.

8. A rotor blade according to claim 7, wherein the actuator comprises one of the group of a hydraulic piston and an electric motor with a spindle.

9. A rotor blade according to claim 7, wherein the deployment means is configured to receive instructing signals from a central controller associated with a wind turbine installation to which the rotor blade is connected, in use.

10. A rotor blade according to claim 6, wherein the deployment means is configured to move the auxiliary component between the first and second portions dependent on an orientation of the rotor blade relative to a hub of a wind turbine installation to which the rotor blade is connected, in use.

11. A rotor blade according to claim 10, wherein the deployment means comprises a push-rod connected to the auxiliary component, the push-rod being configured to engage with a receiving means, the receiving means being fixedly connected to a hub of a wind turbine installation to which the rotor blade is connected, in use.

12. A rotor blade according to claim 10, wherein the deployment means comprises biasing means associated with the push-rod, configured to assist retraction of the auxiliary component.

13. A wind turbine installation comprising:
a tower;
a hub, mounted atop the tower; and
a wind turbine rotor blade, according to claim 1, connected to the hub.
